(19) United States
(12) Patent Application Publication
(10) Pub. No.: US 2022/0395979 A1
(43) Pub. Date: Dec. 15, 2022

(54) AUTOMATED SAFETY ASSESSMENT FOR ROBOT MOTION PLANNING

(71) Applicant: X Development LLC, Mountain View, CA (US)

(72) Inventor: Michael Beardsworth, San Francisco, CA (US)

(21) Appl. No.: 17/348,264

(22) Filed: Jun. 15, 2021

(51) Int. Cl. B25J 9/16; B25J 13/08

(52) U.S. Cl. CPC B25J 9/1666; B25J 9/1676; B25J 9/1651; B25J 9/1661; B25J 13/088

(57) ABSTRACT

Methods, computer systems, and apparatus, including computer programs encoded on computer storage media, for generating safety information for a motion plan for one or more robots in an operating environment. One of the methods includes: obtaining a definition of the motion plan, obtaining data specifying a safety footprint volume for a first robot in the operating environment, obtaining one or more safety constraints for the motion plan according to the safety footprint volume for the first robot, determining whether a first safety constraint of the one or more safety constraints is satisfied, in response to determining that the first safety constraint is not satisfied, generating information indicating a violation of a safety constraint.

### BACKGROUND

This specification relates to robotics, and more particularly to automatic assessment of safety risks during robot task planning.

Robotic motion planning refers to scheduling the physical movements of robots in order to perform tasks. For example, an industrial robot that builds cars can be programmed to first pick up a car part and then weld the car part onto the frame of the car. Each of these actions can themselves include dozens or hundreds of individual movements by robot motors and actuators.

When humans work in the proximity to industrial robots, considerations for operator safety and risk assessments are critical aspects for robotic motion planning, since the robots can potentially cause severe injuries to the operators in an accident. If a particular robotic motion plan is found to be associated with a certain level of risks, safety measures need to be adopted to mitigate the risks. The safety measures can include, for example, replacing or revising the motion plan, installing sensors and/or stopping mechanisms, installing protective barriers, and so on. The choice of the safety measures can depend on multiple factors such as effectiveness of the measure and negative impacts of the measure on costs, resources, and schedules.

### SUMMARY

Traditionally, safety assessments are performed by risk analysis engineers based on safety codes, guidelines, and experience. These assessments require significant amount of analysis, and are expensive, time-consuming, and error prone. In addition, a safety assessment report generated for one workcell or for one set of robotic tasks are usually not transferable to other workcells or other robotic tasks.

This specification generally describes techniques for performing automatic assessment of safety risks during robot task planning. This allows a computer-implemented system to automatically evaluate safety constraints and safeguards of candidate robotic motion plans, and if possible, optimize a candidate robotic motion plan to ensure it meets safety requirements.

In one aspect of the specification, a method is provided for evaluating robotic motion plans. The method can be implemented by a system of one or more computers located in one or more locations.

The system receives a definition of a motion plan for one or more robots in an operating environment, such as in a physical workcell or a virtual representation of the physical workcell. In this specification, a workcell is the physical environment in which the one or more robots operate. Workcells have particular physical properties, e.g., physical dimensions, which impose constraints on how the robots can move within the workcell.

The system further obtains data representing a safety footprint volume for at least one of the one or more robots in the operating environment. The safety footprint volume includes a volume in which the robot operating the motion plan can pose a safety risk to one or more operators of the one or more robots. For example, the safety footprint volume of the robot can include a motion swept volume of the robot according to the motion plan, i.e., a region of space occupied by at least a portion of the robot or a tool held by the robot during an entire execution of the motion plan. The system can compute the motion swept volume of the robot according to the motion plan.

The system further obtains one or more safety constraints for the motion plan according to the safety footprint volume for the robot. An example safety constraint can include the safety footprint volume of the robot not intersecting a volume accessible to an operator.

The system further determines whether the safety constraints are satisfied according to the motion plan. For example, the system can compute a volume accessible to an operator according to a map of the operating environment, and determines whether the motion swept volume of the robot intersects the volume accessible to an operator.

The system further generates report information on whether a safety constraint is violated according to the motion plan, e.g., whether a safety constraint is not satisfied. In some implementations, the system can further compute a safety score for the motion plan based on how many safety constraints are not satisfied, and evaluate the motion plan as one of a plurality of candidate motion plans according to the respective safety scores computed for the candidate motion plans. Further, for a motion plan with safety score being below a threshold score, the system generates a modified motion plan by making one or more modifications to the motion plan.

In general, the described techniques provide a solution for automatically and efficiently evaluating possible violations of safety constraints and safeguards of candidate robotic motion plans, and if possible, optimize a candidate robotic motion plan to ensure it meets safety requirements. The described technique can be implemented as a software framework that receives robotic motion plan data and outputs safety assessment information. The framework can be applied to a diverse range of robot operating environments and robotic tasks, and can improve the cost and time efficiency of robotic safety assessment while reducing potential human errors in the assessment.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a robotic safety assessment system.

FIG. 2 is a flow diagram illustrating an example process for performing safety assessment of a robotic motion plan.

FIG. 3 is a flow diagram illustrating an example process for performing safety assessment of a plurality of candidate robotic motion plan.

Like reference numbers and designations in the various drawings indicate like elements.

### DETAILED DESCRIPTION

Safety and risk assessment is a critical aspect for robotic motion planning, since robots can potentially cause severe injuries to the operators in an accident. Traditionally, safety assessments are performed by risk analysis engineers based on safety codes, guidelines, and experience. These assessments require significant amount of analysis, and are expensive, time-consuming, and error prone.

This specification generally describes a system and associated methods for performing automatic assessment of safety risks during robot task planning. This allows a computer-implemented system to automatically evaluate possible violations of safety constraints and necessary safeguards of candidate robotic motion plans, and if possible, optimize a candidate robotic motion plan to ensure it meets safety requirements.

In this specification, a robot is a machine having a base position, one or more movable components, and a kinematic model that can be used to map desired positions, poses, or both in one coordinate system, e.g., Cartesian coordinates, into commands for physically moving the one or more movable components to the desired positions or poses.

In this specification, a tool is a device that is controlled or operated by a robot. The tool can be a part of and is attached at the end of the kinematic chain of the one or more moveable components of the robot. Example tools include grippers, welding devices, and sanding devices. That is, a robot can include one or more tools.

In this specification, a task is an operation to be performed by a robot or by a tool controlled by the robot. For brevity, when a robot has only one tool, a task can be described as an operation to be performed by the robot as a whole. Example tasks include welding, glue dispensing, part positioning, and surfacing sanding, to name just a few examples. Tasks are generally associated with a type that indicates the tool required to perform the task, as well as a position within a workcell at which the task will be performed.

In this specification, a motion plan is a data structure that provides information for executing an action or a sequence of actions to perform a task, a cluster of tasks, or a transition. Motion plans can be fully constrained, meaning that all values for all controllable degrees of freedom for the robot are represented explicitly or implicitly; or under-constrained, meaning that some values for controllable degrees of freedom are unspecified. In some implementations, in order to actually perform an action corresponding to a motion plan, the motion plan must be fully constrained to include all necessary values for all controllable degrees of freedom for the robot. Thus, at some points in the planning processes described in this specification, some motion plans may be under-constrained, but by the time the motion plan is actually executed on a robot, the motion plan can be fully constrained. In some implementations, a motion plan can include instructions for the robot to “rest,” i.e., to stay in the current position.

In this specification, a motion swept volume is a region of the space that is occupied by at least a portion of a robot or tool during the entire execution of a motion plan. The motion swept volume can be generated by collision geometry associated with the robot-tool system.

In this specification, a blast volume of a robot in the failure state is defined as a region of space occupied by at least a portion of the first robot or a tool operated by the robot during a control or mechanical failure of the robot when executing a motion plan. The blast volume does not necessarily refer to an explosion of some kind, but rather, can be caused by thrown equipment or work pieces resulted from an operation failure, such as failing to grab a component while moving the component.

In this specification, a transition is a motion plan that describes a movement to be performed between a start point and an end point. The start point and end point can be represented by poses, locations in a coordinate system, or tasks to be performed. Transitions can be under-constrained by lacking one or more values of one or more respective controllable degrees of freedom (DOF) for a robot. Some transitions represent free motions. In this specification, a free motion is a transition in which none of the degrees of freedom are constrained. For example, a robot motion that simply moves from pose A to pose B without any restriction on how to move between these two poses is a free motion. During the planning process, the DOF variables for a free motion are eventually assigned values, and path planners can use any appropriate values for the motion that do not conflict with the physical constraints of the workcell.

In this specification, a schedule is data that assigns each task to at least one robot. A schedule also specifies, for each robot, a sequence of actions to be performed by the robot. A schedule also includes dependency information, which specifies which actions must not commence until another action is finished. A schedule can specify start times for actions, end times for actions, or both.

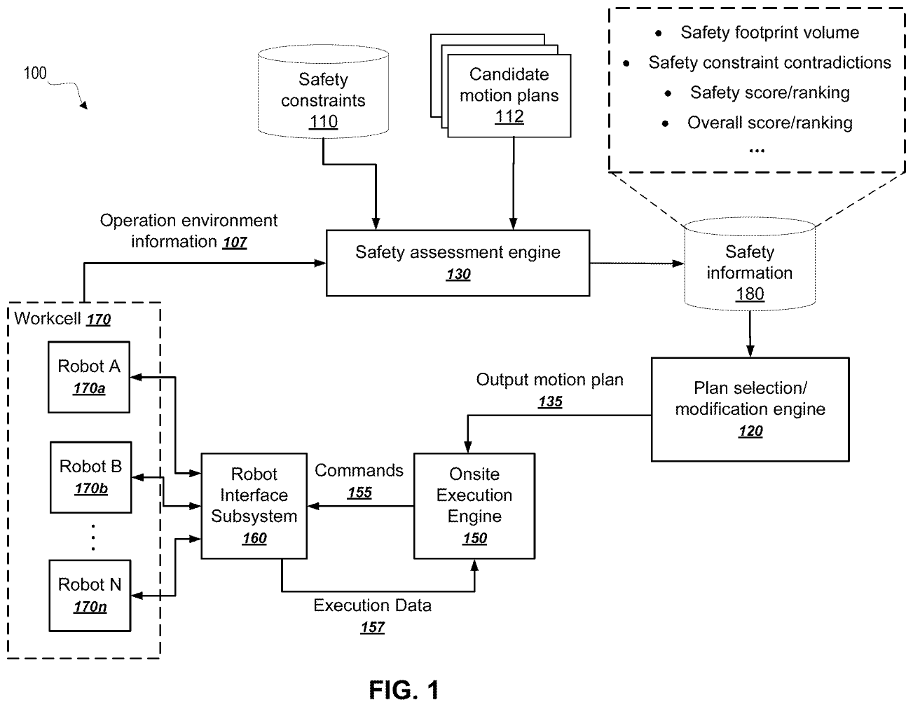

FIG. 1 shows an example of a robotic safety assessment system 100. The system 100 is an example of a system implemented as computer programs on one or more computers in one or more locations, in which the systems, components, and techniques described below can be implemented.

In general, the system 100 includes a safety assessment engine 130 that obtains data 110 specifying one or more safety constraints and data 112 specifying one or more motion plans, and processes the obtained data to generate safety specifying information 180. The data 112 specifies candidate motion plans for one or more robots (e.g., robots 170a, 170b, and 170c) in an operating environment (e.g., the workcell 170).

In some implementations, the safety assessment engine 130 further obtains data 107 that specifies information of the operation environment, e.g., the workcell 170, of the robots, and further uses the data 107 with the data 110 and 120 to generate the safety information 180.

In some implementations, the system 100 further includes a plan selection and modification engine 120 that generates an output motion plan 135 based on the safety information 180 generated by the safety assessment engine 130. The plan selection and modification engine 120 can output the output motion plan 135 to an onsite execution engine 150. The onsite execution engine 150 generates commands 155 based on the output motion plan 135 received from the plan selection and modification engine 120 and execution data 157 received from the robot interface subsystem 160, and issues the generated commands 155 to the robot interface subsystem 160 in order to actually drive the movements of the moveable components, e.g., the joints, of the robots 170a-n.

Each candidate motion plan in data 112 provides information for executing an action or a sequence of actions (e.g., to perform a task, a cluster of tasks, or a transition) by the robots 170a-170n in the operating environment 170. For example, data 112 can include a definition of the candidate motion plan that specifies a sequence of actions for each robot by providing a schedule for the sequence of actions, and for each action, values for some or all of the controllable degrees of freedom of the robot. Examples of values for a controllable degree of freedom can include a target base location of the robot and a target joint angle of one or more joints of the robot.

In some implementations, the operating environment 170 can be a physical environment, e.g., a physical workcell, in which the one or more robots operate in. In some other implementations, the operating environment can be a virtual representation of a physical environment, e.g., a simulated physical workcell, in which simulations of robot motions can be conducted. The physical workcell has particular physical properties, e.g., physical dimensions, which impose constraints on how the robots can move within the workcell. The simulated workcell is associated with numerical parameters that define the physical properties of the simulated workcell, which impose constraints on how the simulated robots can move within the simulated workcell.

The safety assessment engine 130 can obtain the definition of the candidate motion plan (data 112) from various sources via a data transmission interface or a network. For example, in some implementations, the safety assessment engine 130 can receive the definition of the motion plan from a robot motion planning system that automatically generates data defining the motion plan. In some other implementations, the safety assessment engine 130 can receive user input data that defines the motion plan.

In order to make a safety assessment of a candidate motion plan, the safety assessment engine 130 can obtain data specifying a safety footprint volume for the candidate motion plan. The safety assessment engine 130 can obtain the safety footprint volume for each of the robots 170a-170n according to the candidate motion plan. In some implementations, when there are multiple robots executing the motion plan in the operating environment 170, the safety assessment engine 130 can obtain the safety footprint volume by combining the individual safety footprint volumes computed for all the robots executing the candidate motion plan in the operating environment 170.

For a specific robot (referred to as the first robot for convenience) in the one or more robots, the footprint volume of the first robot can be defined as the volume in which the first robot carrying out the motion plan can pose a safety risk to one or more operators of the one or more robots.

In some implementations, the safety footprint volume for the first robot includes a motion swept volume of the first robot according to the motion plan. The motion swept volume of the first robot is defined as a region of space occupied by at least a portion of the first robot or a tool held by the first robot during an entire execution of the motion plan. When carrying out the motion plan, a portion of the first robot or a tool held by the first robot may potentially collide with and endanger an operator accidentally enters the motion swept volume. Therefore, the first robot can potentially pose a safety risk to an operator in the motion swept volume.

The safety assessment engine 130 can obtain the safety footprint volume for the first robot by computing the motion swept volume of the first robot according to the motion plan. For example, the safety assessment engine 130 can track the positions of a plurality of portions of the first robot as well as positions of any tools held by the first robot throughout the motion plan with a constant sampling frequency or varying sampling frequencies, computes portion-specific swept volumes of each of the portions during each interval between two sampling time points, combines the portion-specific swept volumes to form a whole-body swept volume for each of intervals, and combines whole-body swept volume for each of intervals to form the whole-body swept volume for the first robot throughout the motion plan.

In some implementations, the safety footprint volume for the first robot further includes a blast volume of the first robot in a failure state. The blast volume of the first robot in the failure state is defined as a region of space occupied by at least a portion of the first robot or a tool operated by the robot during a control or mechanical failure of the robot when executing the motion plan. In an example, when a robotic arm of the first robot grabs and moves a tool, e.g., a welding device, from one location to another location, a mechanical failure may cause the robotic arm to lose traction of grabbing the tool, resulting in the tool being thrown from the robotic arm. The volume occupied by the travel trajectory of tool that has been thrown from the robotic arm can potentially cause injury to an operator enter the blast volume of the robot in the failure state.

The safety assessment engine 130 can obtain the safety footprint volume for the first robot by combining the computed motion swept volume of the first robot and an estimate for the blast volume of the first robot in the failure state according to the motion plan. In an example process, in order to estimate the blast volume, the safety assessment engine 130 can identify one or more operations of the first robot that may be associated with a control or mechanical failure, such as an operation of grabbing and moving a tool or a component, estimate an operation-specific blast volume for each of the one or more operations according to a buffer radius determined according to the specific operation, and combine the individual operation-specific blast volumes to generate the estimate for the total blast volume of the first robot according to the motion plan. In some implementations, the safety assessment engine 130 can estimate the operation-specific blast volume by conducting a simulation of the dynamics of the operation taking into account physical parameters of the robot and/or the tool/component held by the robot. In some other implementations, the safety assessment engine 130 can estimate the blast volume based on specifications provided by a robot manufacture.

The safety assessment engine 130 can obtain the one or more safety constraints (data 110) from various sources via a data transmission interface or a network. For example, in some implementations, the safety assessment engine 130 can receive user input data that defines the one or more safety constraints. In another example, the safety assessment engine 130 can obtain data defining the one or more safety constraints from a storage device.

The safety constraints can include one or more conditions for maintaining safe operation of the robots and minimizing risks for the operators of the robots. For example, a safety constraint can require that the safety footprint volume for the first robot does not intersect an operator movement volume. The volume accessible to an operator can be defined as a region of space accessible by at least one of the one or more operators during operations of the one or more robots. When there are multiple robots executing the motion plan in the operating environment, the safety constraint can require that the combined safety footprint volumes for the multiple robots does not intersect the volume accessible to an operator. This safety constraint can minimize the risk of an operator colliding with a portion of a robot or a tool being held or operated by the robot.

In another example, the safety constraint can require that the movement speed of the first robot is below a speed threshold when moving in the volume accessible to an operator. When there are multiple robots executing the motion plan in the operating environment, the safety constraint can require that the movement speeds of all of the robots are below the speed threshold when moving in the volume accessible to an operator. This safety constraint can minimize the risk of an operator colliding in high speed with a portion of a robot or a tool being held by the robot. Further, the speed threshold can provide reaction time for the operator to avoid the potential collision.

In another example, the safety constraint can require that the operating environment is equipped with one or more sensors that detect whether the safety footprint volume is at least partially occupied by an operator. The safety constraint can further require that the one or more robots are controlled to stop a motion or to move with a speed not exceeding a speed threshold in response to the one or more sensors detecting the safety footprint volume being at least partially occupied by an operator. Alternatively or additionally, the system constraint can further require that the one or more robots are controlled, in response to the one or more sensors detecting the safety footprint volume being at least partially occupied by an operator, to move in an alternative path.

Next, the safety assessment engine 130 determines whether the one or more safety constraints are satisfied by the motion plan. The safety assessment engine 130 can make the determination by further using the operation environment information 107 or by analyzing the candidate motion plan.

In one example, the safety assessment engine 130 can receive a map of the operating environment 170 that indicates movement paths of the one or more operators in the operating environment, compute the volume accessible to an operator according to the map of the operating environment, and determine whether the safety footprint volume intersects the volume accessible to an operator.

In another example, the safety assessment engine 130 can extract movement speeds of the one or more robots in each of a plurality of time intervals from the motion plan, determine whether the one or more robots are within the volume accessible to an operator in each time interval, and determine whether the movement speeds of the one or more robots are below the speed threshold when the robots are moving in the volume accessible to an operator.

In another example, the safety assessment engine 130 can receive additional information of the operating environment (e.g. the workcell) and the robots, such as whether the operating environment is equipped with motion sensors for the safety footprint volume, and whether the one or more robots are equipped with control mechanisms for emergency stop, speed reduction, and/or path re-routing, in response to the sensor outputs.

In some implementations, the safety information 180 generated by the safety assessment engine 130 includes a safety report that indicates one or more violations of the safety constraints for a specific motion plan when one or more safety constraints are not satisfied. The safety report can further identify the safety constraints and the safety footprint volume of the robots according to the motion plan.

In some implementations, the system 100 can output the safety information 180 via a graphic interface, and display the safety footprint volume of the one or more robots using one or more two-dimensional (2D) or three-dimensional (3D) distribution maps. The system 100 can further display the volume accessible to an operator and/or an intersecting volume between the volume accessible to an operator and the safety footprint volume. In some implementations, the system 100 can display the motion swept volume and the blast volume of each robot in the 2D or 3D maps, and color-code the motion swept volume and the blast volume of different robots in different colors.

In some implementations, the safety assessment engine 130 can compute a safety score for a candidate motion plan based on how many of the one or more safety constraints are satisfied. For example, the safety assessment engine 130 can compute the safety score by normalizing the number of safety constraints that are satisfied by the candidate motion plan by the total number of safety constraints. A higher safety score indicates a higher level of safety profile for the candidate motion plan. In some implementations, when computing the safety score, the system can assign a weight coefficient to each of the safety constraints, and compute the safety score for the motion plan by calculating a sum of the weight coefficients corresponding to the safety constraints that are satisfied by the candidate motion plan. This process allows the system to assign different relevance or importance to each of the safety constraints when calculating the safety score.

Alternatively, the safety assessment engine 130 can compute a safety score for a candidate motion plan based on how many of the one or more safety constraints are not satisfied. The safety assessment engine 130 can subtract one or a corresponding weight coefficient from a baseline safety score for each safety constraint that is not satisfied by the candidate motion plan.

The safety assessment engine 130 can further make recommendations in the safety report, according to the safety score for the motion plan, for remedial modifications of the operating environment and/or the robot control. For example, the safety assessment engine 130 can recommend installing one or more sensors that detect whether the safety footprint volume is at least partially occupied by an operator, and implementing control mechanism for the robots to stop a motion or to reduce the movement speed when the sensors detect the safety footprint volume being at least partially occupied by an operator. In another example, the safety assessment engine 130 can recommend installing a physical barrier, such as a net or a shield at a particular position in the operating environment.

In some implementations, when computing the safety score, the safety assessment engine 130 can assign a weight coefficient to each of the safety constraints, and compute the safety score for the candidate motion plan based on the weight coefficients of the safety constraints that are not satisfied. This allows the system 100 to assign different relevance or importance to each of the safety constraints.

In some implementations, the safety assessment engine 130 can compute an overall score for the motion plan and include the overall score in the safety information 180. The overall score can be computed based on the safety score and one or more additional performance measures for the motion plan. Examples of the one or more additional performance measures can include: time required to execute the motion plan, electrical power consumed when executing the motion plan, complexity of operations of the motion plan, and additional remedial measures required for the motion plan. The overall score can provide a comprehensive measure of the candidate motion plan.

The plan selection/modification engine 120 can evaluate a candidate motion plan according to the computed safety score. If the safety score is below a threshold score, the plan selection/modification engine 120 can determine to reject the corresponding candidate motion plan. Alternatively, the plan selection/modification engine 120 can make modifications to the candidate motion plan if the safety score is below a threshold score and output the modified candidate motion plan as the output motion plan 135. For example, the plan selection/modification engine 120 can modify a movement path of a robot to avoid the safety footprint volume of the robot intersecting the volume accessible to an operator. In another example, the plan selection/modification engine 120 can reduce the movement speed of a motion of a robot to guarantee that the movement speed of the robot is below the speed threshold when moving in the volume accessible to an operator.

After the safety assessment engine 130 calculates the safety scores for each of the candidate motion plans, the plan selection/modification engine 120 can rank the candidate motion plans according to the computed safety scores. For example, the plan selection/modification engine 120 can rank the candidate motion plans having higher safety scores as higher ranked candidate motion plans. The plan selection/modification engine 120 can select an output motion plan from the plurality of candidate motion plans according to the ranking. For example, the plan selection/modification engine 120 can select the top ranked candidate motion plan as the output motion plan.

In some implementations, the plan selection/modification engine 120 can further use the overall scores computed for the candidate motion plans for the ranking of the candidate motion plans and/or the selection of the output motion plan. For example, for two different candidate motion plans that have the same safety scores, the plan selection/modification engine 120 can place a higher ranking to the candidate motion plan that has a higher overall score, and select the higher-ranked candidate motion plan as the output motion plan 135.

The plan selection and modification engine 120 can output the output motion plan 135 to an onsite execution engine 150. The onsite execution engine 150 generates commands 155 based on the output motion plan 135 received from the plan selection and modification engine 120 and execution data 157 received from the robot interface subsystem 160, and issues the generated commands 155 to the robot interface subsystem 160 in order to actually drive the movements of the moveable components, e.g., the joints, of the robots 170a-n.

The robot interface subsystem 160 can provide a hardware-agnostic interface so that the commands 155 issued by onsite execution engine 150 are compatible with multiple different versions of robots. During execution the robot interface subsystem 160 can report execution data 157 back to the onsite execution engine 150 so that the onsite execution engine 150 can make real-time or near real-time adjustments to the robot movements, e.g., due to local faults or other unanticipated conditions.

In execution, the robots 170a-n can continually execute the commands specified explicitly or implicitly by the motion plans to perform the various tasks or transitions of the schedule. The robots can be real-time robots, which means that the robots are programmed to continually execute their commands according to a highly constrained timeline. For example, each robot can expect a command from the robot interface subsystem 160 at a particular frequency, e.g., 100 Hz or 1 kHz. If the robot does not receive a command that is expected, the robot can enter a fault mode and stop operating.

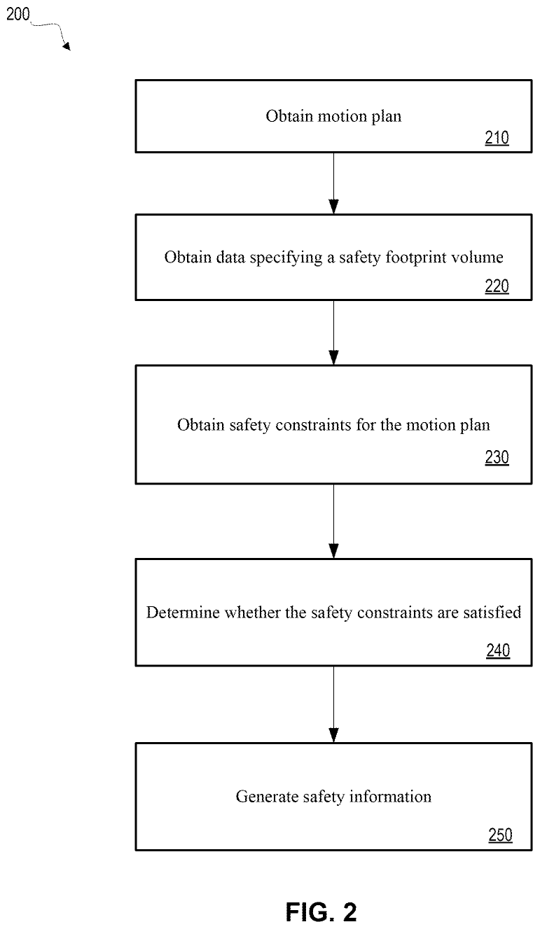

FIG. 2 is a flow diagram illustrating an example process 200 for performing safety assessment of a robotic motion plan. For convenience, the process 200 will be described as being performed by a system of one or more computers located in one or more locations. For example, a robotic safety assessment system, e.g., the robotic safety assessment system 100 of FIG. 1, appropriately programmed in accordance with this specification, can perform the process 200.

In general, in performing the process 200, the system generates safety information associated with a motion plan for one or more robots in an operating environment according to one or more safety constraints. For example, the system can analyze the motion plan, determine whether a specific safety constraint is satisfied, and generate information indicating a violation of a safety constraint.

In step 210, the system obtains a definition of a motion plan for one or more robots in an operating environment. The definition of the motion plan can provide information for executing an action or a sequence of actions (e.g., to perform a task, a cluster of tasks, or a transition) by the one or more robots in the operating environment. For example, the definition of the motion plan can specify a sequence of actions for a robot by providing a schedule for the sequence of actions, and for each action, values for some or all of the controllable degrees of freedom of the robot. Examples of values for a controllable degree of freedom can include a target base location of the robot and a target joint angle of one or more joints of the robot.

In some implementations, the operating environment can be a physical environment, e.g., a physical workcell, in which the one or more robots operate in. In some other implementations, the operating environment can be a virtual representation of a physical environment, e.g., a simulated physical workcell, in which simulations of robot motions can be conducted. The physical workcell has particular physical properties, e.g., physical dimensions, which impose constraints on how the robots can move within the workcell. The simulated workcell is associated with numerical parameters that define the physical properties of the simulated workcell, which impose constraints on how the simulated robots can move within the simulated workcell.

The system can obtain the definition of the motion plan from various sources via a data transmission interface or a network. For example, in some implementations, the system can receive the definition of the motion plan from a robot motion planning system that automatically generates data defining the motion plan. In some other implementations, the system can receive user input data that defines the motion plan.

In step 220, the system obtains data specifying a safety footprint volume for the motion plan. The system can obtain the safety footprint volume for each of the one or more robots according to the motion plan. In some implementations, when there are multiple robots executing the motion plan in the operating environment, the system can obtain the safety footprint volume by combining the individual safety footprint volumes of all the robots executing the motion plan in the operating environment.

For a specific robot (referred to as the first robot for convenience) in the one or more robots, the footprint volume of the first robot can be defined as the volume in which the first robot carrying out the motion plan can pose a safety risk to one or more operators of the one or more robots.

In some implementations, the safety footprint volume for the first robot includes a motion swept volume of the first robot according to the motion plan. The motion swept volume of the first robot is defined as a region of space occupied by at least a portion of the first robot or a tool held by the first robot during an entire execution of the motion plan. When carrying out the motion plan, a portion of the first robot or a tool held by the first robot may potentially collide with and endanger an operator accidentally entering the motion swept volume. Therefore, the first robot can potentially pose a safety risk to an operator in the motion swept volume.

The system can obtain the safety footprint volume for the first robot by computing the motion swept volume of the first robot according to the motion plan. For example, the system can track the positions of a plurality of portions of the first robot as well as positions of any tools held by the first robot throughout the motion plan with a constant sampling frequency or varying sampling frequencies, computes portion-specific swept volumes of each of the portions during each interval between two sampling time points, combines the portion-specific swept volumes to form a whole-body swept volume for each of intervals, and combines whole-body swept volume for each of intervals to form the whole-body swept volume for the first robot throughout the motion plan.

In some implementations, the safety footprint volume for the first robot further includes a blast volume of the first robot in a failure state. The blast volume of the first robot in the failure state is defined as a region of space occupied by at least a portion of the first robot or a tool operated by the robot during a control or mechanical failure of the robot when executing the motion plan. In an example, when a robotic arm of the first robot grabs and moves a tool, e.g., a welding device, from one location to another location, a mechanical failure may cause the robotic arm to lose traction of grabbing the tool, resulting in the tool being thrown from the robotic arm. The volume occupied by the travel trajectory of tool that has been thrown from the robotic arm can potentially cause injury to an operator enter the blast volume of the robot in the failure state.

The system can obtain the safety footprint volume for the first robot by combining the computed motion swept volume of the first robot and an estimate for the blast volume of the first robot in the failure state according to the motion plan. In an example process, in order to estimate the blast volume, the system can identify one or more operations of the first robot that may be associated with a control or mechanical failure, such as an operation of grabbing and moving a tool or a component, estimate an operation-specific blast volume for each of the one or more operations according to a buffer radius determined according to the specific operation, and combine the individual operation-specific blast volumes to generate the estimate for the total blast volume of the first robot according to the motion plan. In some implementations, the system can estimate the operation-specific blast volume by conducting a simulation of the dynamics of the operation taking into account physical parameters of the robot and/or the tool/component held by the robot. In some other implementations, the system can estimate the blast volume based on specifications provided by a robot manufacture.

In step 230, the system obtains one or more safety constraints for the motion plan. The system can obtain the one or more safety constraints from various sources via a data transmission interface or a network. For example, in some implementations, the system can receive user input data that defines the one or more safety constraints. In another example, the system can obtain data defining the one or more safety constraints from a storage device.

The safety constraints can include one or more conditions for maintaining safe operation of the robots and minimizing risks for the operators of the robots. For example, a safety constraint can require that the safety footprint volume for the first robot does not intersect a volume accessible to an operator. The volume accessible to an operator can be defined as a region of space accessible by at least one of the one or more operators during operations of the one or more robots. When there are multiple robots executing the motion plan in the operating environment, the safety constraint can require that the combined safety footprint volumes for the multiple robots does not intersect the volume accessible to an operator. This safety constraint can minimize the risk of an operator colliding with a portion of a robot or a tool being held or operated by the robot.

In another example, the safety constraint can require that the movement speed of the first robot is below a speed threshold when moving in the volume accessible to an operator. When there are multiple robots executing the motion plan in the operating environment, the safety constraint can require that the movement speeds of all of the robots are below the speed threshold when moving in the volume accessible to an operator. This safety constraint can minimize the risk of an operator colliding in high speed with a portion of a robot or a tool being held by the robot. Further, the speed threshold can provide reaction time for the operator to avoid the potential collision.

In another example, the safety constraint can require that the operating environment is equipped with one or more sensors that detect whether the safety footprint volume is at least partially occupied by an operator. The safety constraint can further require that the one or more robots are controlled to stop a motion or to move with a speed not exceeding a speed threshold in response to the one or more sensors detecting the safety footprint volume being at least partially occupied by an operator. Alternatively or additionally, the system constraint can further require that the one or more robots are controlled, in response to the one or more sensors detecting the safety footprint volume being at least partially occupied by an operator, to move in an alternative path.

In step 240, the system determines whether the one or more safety constraints are satisfied by the motion plan.

In one example, the system can receive a map of the operating environment that indicates movement paths of the one or more operators in the operating environment, compute the volume accessible to an operator according to the map of the operating environment, and determine whether the safety footprint volume intersects the volume accessible to an operator.

In another example, the system can extract movement speeds of the one or more robots in each of a plurality of time intervals from the motion plan, determine whether the one or more robots are within the volume accessible to an operator in each time interval, and determine whether the movement speeds of the one or more robots are below the speed threshold when the robots are moving in the volume accessible to an operator.

In another example, the system can receive additional information of the operating environment (e.g. the workcell) and the robots, such as whether the operating environment is equipped with motion sensors for the safety footprint volume, and whether the one or more robots are equipped with control mechanisms for emergency stop, speed reduction, and/or path re-routing, in response to the sensor outputs.

In step 250, the system generates safety information. For example, in some implementations, the system can generate a safety report that indicates a violation of a safety constraint of the motion plan. The safety report can further identify the safety constraints and the safety footprint volume of the robots according to the motion plan.

In some implementations, the system can output the safety information via a graphic interface, and display the safety footprint volume of the one or more robots using one or more two-dimensional (2D) or three-dimensional (3D) distribution maps. The system can further display the volume accessible to an operator and/or an intersecting volume between the volume accessible to an operator and the safety footprint volume. In some implementations, the system can display the motion swept volume and the blast volume of each robot in the 2D or 3D maps, and color-code the motion swept volume and the blast volume of different robots in different colors.

In some implementations, the system can compute a safety score for the motion plan based on how many of the one or more safety constraints are satisfied. The system can further evaluate the motion plan according to the computed safety score. If the safety score is below a threshold score, the system can determine to reject the motion plan as a candidate motion plan. Alternatively, the system can make modifications to the motion plan if the safety score is below a threshold score and output the modified candidate motion plan as an output motion plan. For example, the system can modify a movement path of a robot to avoid the safety footprint volume of the robot intersecting the volume accessible to an operator. In another example, the system can reduce the movement speed of a motion of a robot to guarantee that the movement speed of the robot is below the speed threshold when moving in the volume accessible to an operator.

The system can further make recommendations in the safety report, according to the safety score for the motion plan, for remedial modifications of the operating environment and/or the robot control. For example, the system can recommend installing one or more sensors that detect whether the safety footprint volume is at least partially occupied by an operator, and implementing a control mechanism for the robots to stop a motion or to reduce the movement speed when the sensors detect the safety footprint volume being at least partially occupied by an operator. In another example, the system can recommend installing a physical barrier, such as a net or a shield at a particular position in the operating environment.

In some implementations, when computing the safety score, the system can assign a weight coefficient to each of the safety constraints, and compute the safety score for the motion plan based on the weight coefficients of the safety constraints that are not satisfied. This allows the system to assign different relevance or importance to each of the safety constraints.

In some implementations, the system can compute an overall score for the motion plan and include the overall score in the safety information. The overall score can be computed based on the safety score and one or more additional performance measures for the motion plan. Examples of the one or more additional performance measures can include: time required to execute the motion plan, electrical power consumed when executing the motion plan, complexity of operations of the motion plan, and additional remedial measures required for the motion plan. The overall score can provide a comprehensive measure of the motion plan.

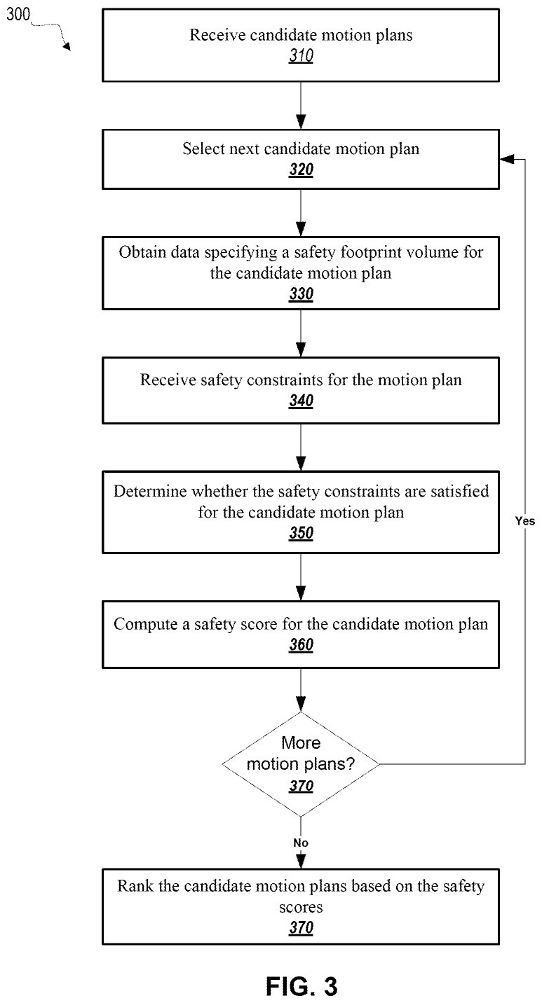

FIG. 3 is a flow diagram illustrating an example process 300 for performing safety assessment of a plurality of candidate robotic motion plans. For convenience, the process 300 will be described as being performed by a system of one or more computers located in one or more locations. For example, a robotic safety assessment system, e.g., the robotic safety assessment system 100 of FIG. 1, appropriately programmed in accordance with this specification, can perform the process 300.

In general, in performing the process 300, the system evaluates and ranks the plurality of candidate motion plans for one or more robots in an operating environment according to respective safety scores computed the candidate motion plans. For example, the system can analyze each candidate motion plan, determine whether one or more specific safety constraints are satisfied by the candidate motion plan, compute the safety score of the candidate motion plan according to how many of the one or more safety constraints are not satisfied by the candidate motion plan, and rank the motion plans according to their respective safety scores.

In step 310, the system obtains definitions of a plurality of candidate motion plans for one or more robots in an operating environment. The plurality of candidate motion plans can aim to perform the same task, the same cluster of tasks, or the same transition. However, the plurality of candidate motion plans can be different from each other. For example, each candidate motion plan can have a unique combination of movement paths or sequences for at least one robot compared to other candidate motion plans.

Similar to the description with reference to FIG. 2, the operating environment can be a physical environment, e.g., a physical workcell, or a virtual representation of a physical environment, e.g., a simulated physical workcell. The system can obtain the definition of each candidate motion plan from various sources via a data transmission interface or a network, for example, by receiving the definition of the candidate motion plan from a robot motion planning system or by receiving user input data that defines the candidate motion plan.

For each candidate motion plan in the plurality of candidate motion plans, the system performs steps 320-360.

In step 320, the system selects the next candidate motion plan from the plurality of candidate motion plans.

In step 330, the system obtains data specifying a safety footprint volume for the candidate motion plan. Details of the process are similarly described with reference to step 220 of FIG. 2. Briefly, the system can obtain the safety footprint volume for each of the one or more robots according to the candidate motion plan. When there are multiple robots executing the motion plan in the operating environment, the system can obtain the safety footprint volume by combining the individual safety footprint volumes of all the robots executing the candidate motion plan in the operating environment.

For a specific robot (referred to as the first robot for convenience) in the one or more robots, the safety footprint volume can include a motion swept volume of the first robot according to the candidate motion plan. The system can obtain the safety footprint volume for the first robot by computing the motion swept volume of the first robot according to the motion plan.

In some implementations, the safety footprint volume for the first robot further includes a blast volume of the first robot in a failure state. The system can obtain the safety footprint volume for the first robot by combining the computed motion swept volume of the first robot and an estimate for the blast volume of the first robot in the failure state according to the motion plan.

In step 340, the system obtains one or more safety constraints for the candidate motion plan. Details of the process are similarly described with reference to step 230 of FIG. 2. Briefly, the system can obtain the one or more safety constraints from various sources via a data transmission interface or a network, such as receiving user input data that defines the one or more safety constraints, or obtaining data defining the one or more safety constraints from a storage device.

The safety constraints can include one or more conditions for maintaining safe operation of the robots and minimizing risks for the operators of the robots. Examples of the safety constraints include the safety footprint volume for the first robot not intersecting a volume accessible to an operator, a movement speed of the first robot being below a speed threshold when moving in the volume accessible to an operator, the operating environment being equipped with one or more sensors that detect whether the safety footprint volume is at least partially occupied by an operator, and so on.

In step 350, the system determines whether the one or more safety constraints are satisfied by the candidate motion plan. Details of the process are similarly described with reference to step 240 of FIG. 2. Briefly, the system can obtain information of the operating environment and/or the control of the robots, or extract features of the candidate motion plan, and determine whether the safety constraints are satisfied based on the obtained information or the extracted features.

In step 360, the system computes a safety score for the candidate motion plan. In some implementations, the system can compute a safety score for the candidate motion plan based on how many of the one or more safety constraints are satisfied. For example, in some implementations, the system can compute the safety score by normalizing the number of safety constraints that are satisfied by the candidate motion plan by the total number of safety constraints. In some implementations, when computing the safety score, the system can assign a weight coefficient to each of the safety constraints, and compute the safety score for the motion plan by calculating a sum of the weight coefficients corresponding to the safety constraints that are satisfied by the candidate motion plan. This process allows the system to assign different relevance or importance to each of the safety constraints when calculating the safety score.

Alternatively, the system can compute the safety score for a candidate motion plan based on how many of the one or more safety constraints are not satisfied. The system can subtract one or a corresponding weight coefficient from a baseline safety score for each safety constraint that is not satisfied by the candidate motion plan.

In some implementations, the system can further compute an overall score for the candidate motion plan based on the safety score and one or more additional performance measures for the motion plan. Examples of the one or more additional performance measures can include: time required to execute the motion plan, electrical power consumed when executing the motion plan, complexity of operations of the motion plan, and additional remedial measures required for the motion plan. The overall score can provide a comprehensive measure of the candidate motion plan. For example, two different motion plans may have similar safety scores, but one of the motion plans may have better additional measures, e.g., being more time or energy efficient. The overall scores can capture the additional performance features of the candidate motion plan that can be helpful for selecting a candidate motion plan.

In step 370, the system determines whether there are more motion plans in the plurality of motion plans, returns to step 320 when there are more motion plans, and proceeds to step 370 when there are no more motion plans.

In step 370, the system ranks the candidate motion plans according to the computed safety scores. For example, the system can rank the candidate motion plans having higher safety scores as higher ranked candidate motion plans. In some implementations, the system can select an output motion plan from the plurality of candidate motion plans according to the ranking. For example, the system can select the top ranked candidate motion plan as the output motion plan.

In some implementations, the system can further use the overall scores computed for the candidate motion plans for the ranking of the candidate motion plans and/or the selection of the output motion plan. For example, for two different candidate motion plans that have the same safety scores, the system can place a higher ranking to the candidate motion plan that has a higher overall score, and select the higher-ranked candidate motion plan as the output motion plan.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by a data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, which is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, one or more programmable logic controllers (PLCs) or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claim is:

1. A computer-implemented method, comprising:
obtaining a definition of a motion plan for one or more robots in an operating environment;
obtaining data specifying a safety footprint volume for a first robot in the operating environment, wherein the safety footprint volume comprises a volume in which the first robot operating the motion plan can pose a safety risk to one or more operators of the one or more robots;
obtaining one or more safety constraints for the motion plan according to the safety footprint volume for the first robot;
determining whether a first safety constraint of the one or more safety constraints is satisfied; and
in response to determining that the first safety constraint is not satisfied, generating information representing a violation of the first safety constraint.

2. The method of claim 1, wherein:
the safety footprint volume for the first robot includes a motion swept volume of the first robot according to the motion plan, the motion swept volume being a region of space occupied by at least a portion of a robot or a tool held by the robot during an entire execution of the motion plan; and
obtaining the data representing the safety footprint volume for the first robot comprises computing the motion swept volume of the first robot according to the motion plan.

3. The method of claim 2, wherein:
the safety footprint volume for the first robot further includes a blast volume of the first robot in a failure state, the blast volume in the failure state being a region of space occupied by at least a portion of a robot or a tool operated by the robot during a control or mechanical failure of the robot; and
obtaining the data representing the safety footprint volume for the first robot further comprises estimating the blast volume in the failure state of the first robot.

4. The method of claim 1, further comprising:
obtaining a volume accessible to an operator, the volume accessible to an operator including a region of space accessible by at least one of the one or more operators during an operation of the first robot.

5. The method of claim 4, wherein obtaining the volume accessible to an operator comprises: computing the volume accessible to an operator according to a map of the operating environment.

6. The method of claim 4, wherein the first safety constraint includes: the safety footprint volume for the first robot not intersecting the volume accessible to an operator.

7. The method of claim 4, wherein the first safety constraint includes:
a movement speed of the first robot being below a speed threshold when moving in the volume accessible to an operator.

8. The method of claim 1, wherein the first safety constraint includes: the operating environment being equipped with one or more sensors that detect whether the safety footprint volume is at least partially occupied by an operator.

9. The method of claim 8, wherein the first safety constraint further includes: the first robot being controlled, in response to the one or more sensors detecting the safety footprint volume being at least partially occupied by an operator, to stop a motion or to move with a speed not exceeding a speed threshold.

10. The method of claim 8, wherein the first safety constraint further includes:
the first robot being controlled, in response to the one or more sensors detecting the safety footprint volume being at least partially occupied by an operator, to move in an alternative path.

11. The method of claim 1, wherein generating the information indicating the violation of the safety constraint comprises:
generating a report identifying the one or more safety constraints and identifying the safety footprint volume.

12. The method of claim 1, wherein the operating environment is a physical workcell or a virtual representation of the physical workcell.

13. The method of claim 1, further comprising:
computing a safety score for the motion plan based on how many of the one or more safety constraints are satisfied.

14. The method of claim 13, further comprising:
evaluating the motion plan as one of a plurality of candidate motion plans according to the safety score computed for the motion plan; and
in response to the safety score being below a threshold score, rejecting the motion plan as a candidate motion plan or generating an output motion plan by making one or more modifications to the motion plan.

15. The method of claim 13, further comprising:
computing an overall score for the motion plan based on the safety score and one or more additional performance measures for the motion plan.

16. The method of claim 15, further comprising:
generating a ranking result for ranking the plurality of candidate motion plans according to at least one of: the safety scores or the overall scores computed for the plurality of candidate motion plans; and
selecting an output motion plan from the plurality of candidate motion plans based on the ranking result.

17. A system comprising one or more computers and one or more storage devices storing instructions that when executed by the one or more computers cause the one or more computers to perform:
obtaining a definition of a motion plan for one or more robots in an operating environment;
obtaining data specifying a safety footprint volume for a first robot in the operating environment, wherein the safety footprint volume comprises a volume in which the first robot operating the motion plan can pose a safety risk to one or more operators of the one or more robots;
obtaining one or more safety constraints for the motion plan according to the safety footprint volume for the first robot;
determining whether a first safety constraint of the one or more safety constraints is satisfied; and
in response to determining that the first safety constraint is not satisfied, generating information representing a violation of the first safety constraint.

18. The system of claim 17, wherein:
the safety footprint volume for the first robot includes a motion swept volume of the first robot according to the motion plan, the motion swept volume being a region of space occupied by at least a portion of a robot or a tool held by the robot during an entire execution of the motion plan; and
obtaining the data representing the safety footprint volume for the first robot comprises computing the motion swept volume of the first robot according to the motion plan.

19. One or more computer storage media storing instructions that when executed by one or more computers cause the one or more computers to perform:
obtaining a definition of a motion plan for one or more robots in an operating environment;
obtaining data specifying a safety footprint volume for a first robot in the operating environment, wherein the safety footprint volume comprises a volume in which the first robot operating the motion plan can pose a safety risk to one or more operators of the one or more robots;
obtaining one or more safety constraints for the motion plan according to the safety footprint volume for the first robot;
determining whether a first safety constraint of the one or more safety constraints is satisfied; and
in response to determining that the first safety constraint is not satisfied, generating information representing a violation of the first safety constraint.

20. The one or more computer storage media of claim 19, wherein:
the safety footprint volume for the first robot includes a motion swept volume of the first robot according to the motion plan, the motion swept volume being a region of space occupied by at least a portion of a robot or a tool held by the robot during an entire execution of the motion plan; and
obtaining the data representing the safety footprint volume for the first robot comprises computing the motion swept volume of the first robot according to the motion plan.
